(19) United States
(12) Patent Application Publication
(10) Pub. No.: US 2024/0011509 A1
(43) Pub. Date: Jan. 11, 2024

(54) EJECTOR

(71) Applicant: AISAN KOGYO KABUSHIKI KAISHA, Obu-shi (JP)

(72) Inventor: Sadatsugu NAGATA, Aichi-gun (JP)

(73) Assignee: AISAN KOGYO KABUSHIKI KAISHA, Obu-shi (JP)

(21) Appl. No.: 18/341,341

(22) Filed: Jun. 26, 2023

(30) Foreign Application Priority Data
Jul. 8, 2022 (JP) 2022-110528

(51) Int. Cl. F04F 5/46

(52) U.S. Cl. CPC F04F 5/466; F04F 5/463

(57) ABSTRACT

An ejector includes an inner nozzle, an outer nozzle internally provided with the inner nozzle, and an outer injection port between the inner nozzle and the outer nozzle. The ejector is operated to suck a target fluid by negative pressure generated by a working fluid injected from the inside of the inner nozzle or/and the outer injection port, and discharge the target fluid merged with the working fluid. The ejector further includes a nozzle guide placed in the gap between the inner nozzle and the outer nozzle and configured to restrict the interval of the outer injection port.

### CROSS-REFERENCE TO RELATED APPLICATIONS

This application is based upon and claims the benefit of priority to Japanese Patent Application No. 2022-110528 filed on Jul. 8, 2022, the entire contents of which are incorporated herein by reference.

### BACKGROUND

### Technical Field

The present disclosure relates to an ejector configured to flow a working fluid, generating negative pressure, to allow a target fluid to flow under the action of the negative pressure.

### Related Art

Japanese unexamined patent application publication No. 2002-056869 (JP 2002-056869A) discloses an ejector with nozzles for injecting a working fluid, including a first nozzle which is an inner nozzle and a second nozzle which is an outer nozzle internally provided with the first nozzle.

### SUMMARY

### Technical Problems

In the ejector disclosed in JP2002-056869A, the first nozzle and the second nozzle are arranged in a positional relationship that the first nozzle and the second nozzle are coaxial. However, during and after the assembly of the first and second nozzles, the first nozzle may become eccentric with respect to the second nozzle and thus the first and second nozzles could not maintain a desired positional relationship, that is, a coaxial relationship. Consequently, the ejector could not stably inject a working fluid from between the first and second nozzles, resulting in an unstable flow rate of a target fluid induced to flow under the action of the working fluid.

The present disclosure has been made to address the above problems and has a purpose to provide an ejector capable of maintaining a desired positional relationship between an inner nozzle and an outer nozzle.

### Means of Solving the Problems

To achieve the above-mentioned purpose, one aspect of the present disclosure provides an ejector comprising: an inner nozzle; and an outer nozzle internally provided with the inner nozzle, wherein the inner nozzle and the outer nozzle are spaced with a gap, the ejector is configured to suck a target fluid by negative pressure that is generated by a working fluid injected from at least one of an inside of the inner nozzle and the gap and discharge the target fluid merged with the working fluid, and the ejector includes an interval restricting part placed in the gap and configured to restrict an interval of the gap.

According to the above configuration, the interval, or radial distance, of the gap between the inner nozzle and the outer nozzle is restricted by the interval restricting part, so that the inner and outer nozzles can be maintained in a desired positional relationship. This configuration stabilizes a flow rate of the working fluid to be injected from the gap between the inner and outer nozzles, and thus can stabilize a flow rate of the target fluid caused to flow under the action of the working fluid, thereby allowing a desired flow rate of the target fluid to flow.

The ejector of the present disclosure can maintain the inner and outer nozzles in a desired positional relationship.

### BRIEF DESCRIPTION OF THE DRAWINGS

FIG. 1 is a cross-sectional view of an ejector in an embodiment;

FIG. 2 is an enlarged view of distal ends of an inner nozzle and outer nozzle and their surroundings;

FIG. 3 is a cross-sectional view along A-A in FIG. 2 in a first example, in which a cross-sectional part of a body casing is omitted for convenience of explanation;

FIG. 4 is a diagram showing a nozzle guide seen from inside of the outer nozzle;

FIG. 5 is a developed planar view of an inner periphery of an outer nozzle in a second example;

FIG. 6 is a cross-sectional view along A-A in FIG. 2 in a third example, in which a cross-sectional part of a body casing is omitted for convenience of explanation;

FIG. 7 is a cross-sectional view along A-A in FIG. 2 in a fourth example, in which a cross-sectional part of a body casing is omitted for convenience of explanation;

FIG. 8 is a diagram showing the shape of a suction port of a diffuser in a modified example; and

FIG. 9 is an enlarged view of distal ends of an inner nozzle and outer nozzle and their surroundings in a conventional art.

### DETAILED DESCRIPTION OF THE EXEMPLARY EMBODIMENTS

A detailed description of an ejector 1 in an embodiment of this disclosure will now be given referring to the accompanying drawings.

### Overview of the Entire Ejector

The overview of the entire ejector 1 will be described first.

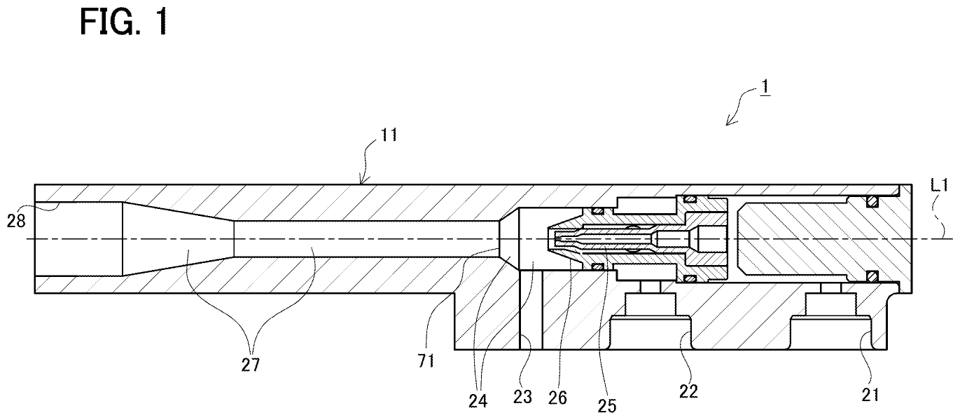

As shown in FIG. 1, the ejector 1 includes a body casing 11. This body casing 11 is formed in a tubular shape to flow a working fluid, such as hydrogen gas, and a target fluid, such as hydrogen off-gas.

The body casing 11 includes a first working fluid supply port 21, a second working fluid supply port 22, a target fluid supply port 23, a negative-pressure generating chamber 24, an inner nozzle 25, an outer nozzle 26, a diffuser 27, and a discharge port 28.

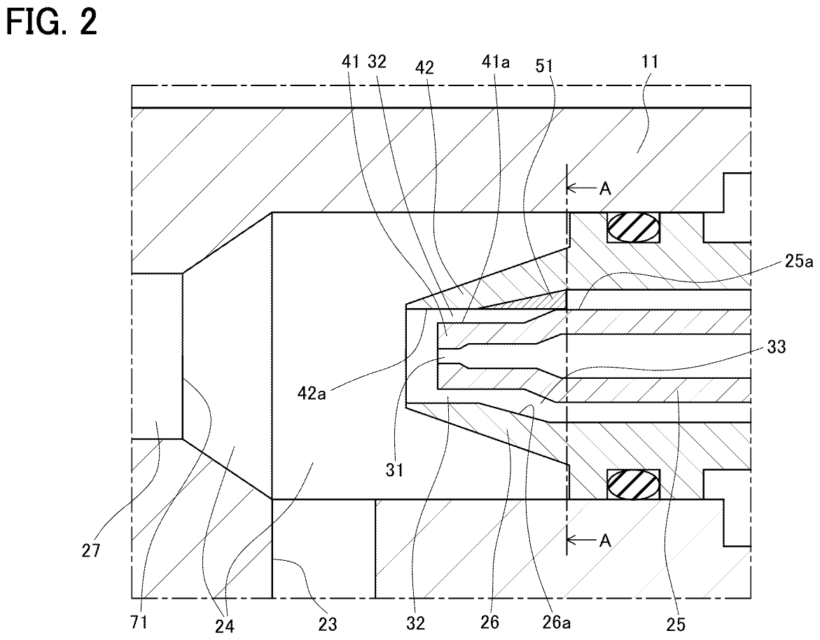

The first working fluid supply port 21 is an inlet through which the working fluid is supplied to the ejector 1. This port 21 is connected to an inner injection port 31 (see FIG. 2) which is an inner flow channel of the inner nozzle 25. The second working fluid supply port 22 is an inlet through which the working fluid is supplied to the ejector 1. This port 22 is connected to an outer injection port 32 (see FIG. 2) which is a flow channel corresponding to the gap between the inner nozzle 25 and the outer nozzle 26.

The target fluid supply port 23 is an inlet through which the target fluid is supplied to the ejector 1 and is connected to a negative-pressure generating chamber 24. This chamber 24 is a space for generating negative pressure by the working fluid.

The inner nozzle 25 and the outer nozzle 26 are used to inject the working fluid supplied through the first working fluid supply port 21 and the second working fluid supply port 22, respectively. These inner nozzle 25 and outer nozzle 26 are each made of stainless steel, resin, or others and formed in a nearly cylindrical shape. The outer nozzle 26 is internally provided with the inner nozzle 25. This inner nozzle 25 is for example fixed to the outer nozzle 26 by press-fitting. A distal end portion 41 of the inner nozzle 25 and a distal end portion 42 of the outer nozzle 26 are located in the negative-pressure generating chamber 24. The distal end portion 41 and the distal end portion 42 are respectively the tip of the inner nozzle 25 and the tip of the outer nozzle 26 on a downstream side in a flowing direction of the working fluid (hereinafter, simply referred to as a downstream side, that is, a left side in FIG. 2), each of which has a minimum inner diameter.

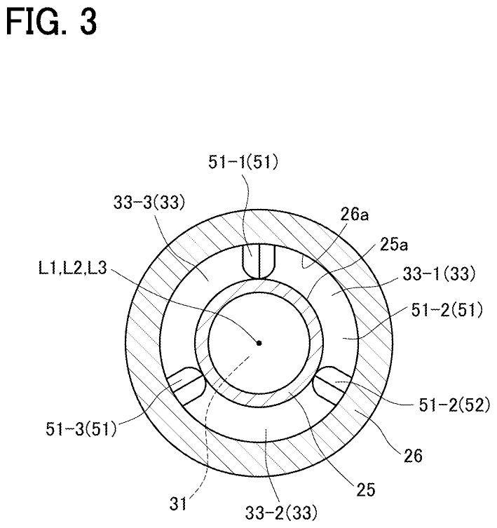

Herein, as one example, the inner nozzle 25 and the outer nozzle 26 are placed in a coaxial positional relationship, that is, the axis L2 of the inner nozzle 25 and the axis L3 of the outer nozzle 26 coincide with each other, as shown in FIGS. 1 to 3. Further, the axis L2 of the inner nozzle 25 and the axis L3 of the outer nozzle 26 coincide with the axis L1 of the diffuser 27, as shown in FIG. 3.

As shown in FIG. 2, the distal end portion 41 of the inner nozzle 25 is internally provided with an inner injection port 31 through which the working fluid flows. The distal end portion 42 of the outer nozzle 26 is provided internally, i.e., in a gap between an outer periphery 41a of the distal end portion 41 of the inner nozzle 25 and an inner periphery 42a of the distal end portion 42 of the outer nozzle 26, with an outer injection port 32 having an annular cross-section, through which the working fluid flows.

In the present embodiment, as shown in FIGS. 2 and 3, at least one nozzle guide 51 is provided at a position upstream in a flowing direction of the working fluid from the outer injection port 32, which will be simply referred to as the “upstream side”, corresponding to the right side in FIG. 2. That is, the nozzle guide 51 is placed at a position upstream from and adjacent to the distal end portion 42, where the inner diameter of the outer nozzle 26 is larger than that of the distal end portion 42, more specifically, where the inner diameter of the outer nozzle 26 is one level larger than the minimum inner diameter. The details of this nozzle guide 51 will be described later. The nozzle guide 51 is one example of an interval restricting part of the present disclosure.

The diffuser 27 is a flow channel that is connected to the negative-pressure generating chamber 24 and configured to suck the target fluid by the negative pressure generated by the working fluid, and deliver the target fluid merged with the working fluid to the discharge port 28. This discharge port 28 is an outlet through which the working fluid and the target fluid are discharged to the outside after flowing through the diffuser 27.

In the ejector 1 configured as above, when the working fluid supplied to the ejector 1 through the first working fluid supply port 21 and the second working fluid supply port 22 is injected from at least one of the inner nozzle 25 and the outer nozzle 26 (i.e., the outer injection port 32), generating negative pressure in the negative-pressure generating chamber 24, the target fluid is sucked by the thus generated negative pressure from the target fluid supply port 23 into the negative-pressure generating chamber 24. The ejector 1 then allows the target fluid merged with the working fluid to flow through the diffuser 27 and discharge through the discharge port 28 toward a supply destination (not shown).

More specifically, the working fluid supplied to the first working fluid supply port 21 flows through the inner nozzle 25 and is injected through the inner injection port 31 into the negative-pressure generating chamber 24. This working fluid then flows through the diffuser 27, and is discharged out through the discharge port 28. Further, the working fluid supplied to the second working fluid supply port 22 flows through the outer nozzle 26 and is injected through the outer injection port 32 into the negative-pressure generating chamber 24. This working fluid then flows through the diffuser 27, and is discharged out through the discharge port 28.

When jetting from inner and outer nozzles 25 and 26, the working fluid generates negative pressure in the negative-pressure generating chamber 24, thereby sucking the target fluid supplied to the target fluid supply port 23 into the negative-pressure generating chamber 24. The target fluid thus flows together with the working fluid through the diffuser 27 while mixing with the working fluid, and this mixed fluid is discharged out of the ejector 1 through the discharge port 28.

### Nozzle Guide

The nozzle guide 51 will be described below.

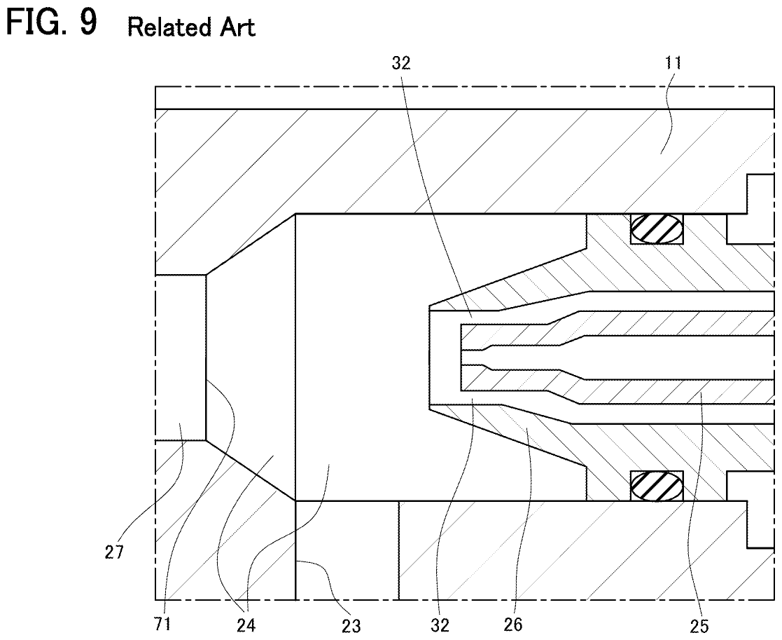

Conventionally, as shown in FIG. 9, nothing is provided in the gap between the inner nozzle 25 and the outer nozzle 26. Therefore, during and after assembly of these inner nozzle 25 and outer nozzle 26, the inner nozzle 25 may incline eccentrically with respect to the outer nozzle 26. If the inner nozzle 25 comes to such an eccentric state, the dimension of the outer injection port 32 becomes uneven, or unbalanced, over the circumferential direction of the nozzles 25 and 26. This causes a decrease in the flow rate of the working fluid injected from the outer injection port 32 or variations in the flow rate of the working fluid injected from the outer injection port 32 in the circumferential direction of the nozzles 25 and 26. If the ejector 1 cannot eject the working fluid stably from the outer injection port 32 as above, the flow rate of the target fluid caused to flow by the action of the working fluid may not be stable, and thus a desired flow rate of the target fluid is not allowed flow.

### First Example

A first example of the present disclosure to address the aforementioned issues will be described below.

In this example, as shown in FIGS. 2 and 3, at least one nozzle guide 51 is placed at a position in the gap between the inner nozzle 25 and the outer nozzle 26 and on an upstream side from the outer injection port 32. The nozzle guide(s) 51 is in contact with an outer periphery 25a of the inner nozzle 25 to restrict the interval of the outer injection port 32. This interval of the outer injection port 32 indicates the distance in the radial direction of the inner nozzle 25 and the outer nozzle 26, which is also referred to as a radial interval.

Specifically, the at least one nozzle guide 51 includes a plurality of nozzle guides 51, or three nozzle guides 51 in the present example, as shown in FIGS. 2 and 3, which are provided on an inner periphery 26a of the outer nozzle 26 upstream from the distal end portion 42 and arranged at equally spaced intervals in the circumferential direction of the outer nozzle 26. The number of nozzle guides 51 is not limited to three, as long as it is two or more. As an alternative to the above, the nozzle guides 51 may be provided on the outer periphery 25a of the inner nozzle 25 upstream from the distal end portion 41. As still another alternative, the nozzle guides 51 may be separate components from the inner nozzle 25 and outer nozzle 26.

Since the radial interval of the outer injection port 32 is restricted by the nozzle guides 51, the inner nozzle 25 is positionally guided in the radial direction of the inner nozzle 25 and the outer nozzle 26 during assembly. This makes it possible to keep constant the interval of the outer injection port 32, that is, the distance of the gap between the outer periphery 41a of the distal end portion 41 of the inner nozzle and the inner periphery 42a of the distal end portion 42 of the outer nozzle 26. Accordingly, the interval of the outer injection port 32 can be kept constant by the nozzle guides 51 during or after assembly of the inner nozzle 25 and the outer nozzle 26, so that the inner nozzle 25 is prevented from inclining to an eccentric position with respect to the outer nozzle 26.

In other words, the inner nozzle 25 and the outer nozzle 26 can be maintained in a desired positional relationship, that is, in a coaxial positional relationship in this example. Thus, the dimension of the outer injection port 32 can be kept equal over the circumferential direction of the inner nozzle 25 and the outer nozzle 26. This can prevent a decrease in the flow rate of the working fluid injected from the outer injection port 32, and hence suppress variations in the flow rate of the working fluid injected from the outer injection port 32 in the circumferential direction of the inner nozzle 25 and the outer nozzle 26. Since the working fluid can be stably injected from the outer injection port 32 as above, stabilizing the flow rate of the target fluid caused to flow by the action of the working fluid, thus allowing the target fluid at a desired flow rate. Therefore, a flow rate of a fluid mixture of the working fluid and the target fluid discharged from the discharge port 28 can be set at a desired flow rate.

Moreover, to prevent the inner nozzle 25 from inclining to an eccentric position with respect to the outer nozzle 26, it is not necessary to lengthen fixed portions of the inner nozzle 25 and the outer nozzle 26 or increase the diameters of these nozzles 25 and 26. Thus, the ejector 1 is suppressed from increasing in dimension.

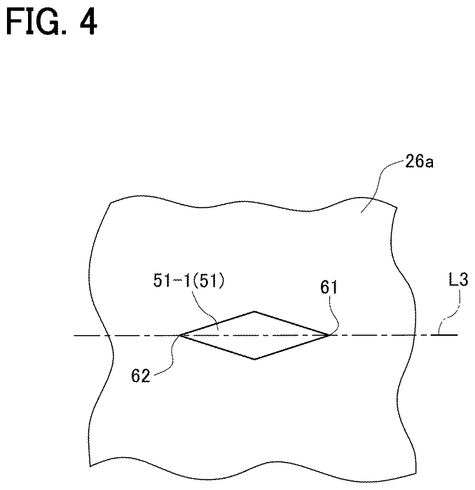

As shown in FIG. 4, each nozzle guide 51 has a diamond shape when seen from inside of the outer nozzle 26. Each nozzle guide 51 is located on the inner periphery 26a of the outer nozzle 26, upstream from the outer injection port 32 (the distal end portion 42), and oriented such that the major axis of the diamond shape is parallel to the flowing direction of the working fluid, i.e., the direction of the axis L3 of the outer nozzle 26. Thus, an end 61 of the nozzle guide 51 on the upstream side (i.e., the right side in FIG. 4), which will be referred to as an upstream-side end 61, has such a shape that converges toward the upstream side. Further, an end 62 of the nozzle guide 51 on the downstream side (i.e., the left side in FIG. 4), which will be referred to as a downstream-side end 62, has such a shape that converged toward the downstream side.

According to the present example described as above, the ejector 1 includes the nozzle guides 51 each serve to restrict the radial interval of the outer injection port 32.

Since the radial interval of the outer injection port 32, i.e., the interval between the outer periphery 41a of the distal end portion 41 of the inner nozzle 25 and the inner periphery 42a of the distal end portion 42 of the outer nozzle 26, is restricted by the nozzle guides 51, the inner nozzle 25 and the outer nozzle 26 can be maintained in a desired positional relationship in the radial direction, that is, in a coaxial relationship. Thus, the ejector 1 can inject the working fluid stably from the outer injection port 32, stabilizing a flow rate of the target fluid caused to flow by the action of the working fluid, allowing the target fluid to flow at a desired flow rate.

Moreover, the nozzle guides 51 are provided upstream from the outer injection port 32.

In other words, the nozzle guides 51 are not placed in the outer injection port 32 located in the distal end portion 42 which is the smallest throttling portion of the outer nozzle 26. Accordingly, the cross-sectional area of the flow channel of the outer injection port 32 is not reduced by the nozzle guides 51. Further, the above-described position of the nozzle guides 51 results in a larger cross-sectional area of the flow channel defined between the inner nozzle 25 and the outer nozzle 26 than when the nozzle guides 51 are provided in the outer injection port 32. According to the above-described position of the nozzle guides 51, additionally, even if a turbulent flow of the working fluid is caused by the nozzle guides 51 acting as a resistance to the working fluid in flowing, this working fluid is stabilized through the outer injection port 32 placed downstream from the nozzle guides 51. Therefore, the inner nozzle 25 and the outer nozzle 26 can be maintained in a desired positional relationship without decreasing a flow rate of the working fluid injected from the outer injection port 32.

The upstream-side end 61 of each nozzle guide 51 is shaped to converge toward the upstream side.

This shape can prevent the nozzle guide 51 from acting as a resistance to a flow of the working fluid, thus preventing the flow rate of the working fluid to be injected from the outer injection port 32 from decreasing due to the nozzle guides 51.

The downstream-side end 62 of each nozzle guide 51 is shaped to converge toward the downstream side.

This shape can rectify a flow of the working fluid. Such a rectified flow of the working fluid allows the target fluid to flow more stably, so that a flow rate of the target fluid is stabilized.

As a modified example, each nozzle guide 51 may be shaped such that only one of the upstream-side end 61 and the downstream-side end 62 is shaped to converge toward a corresponding side, upstream or downstream.

### Second Example

Next, a second example will be described below with a focus on differences from the first example, and similar or identical parts to those in the first example are not described.

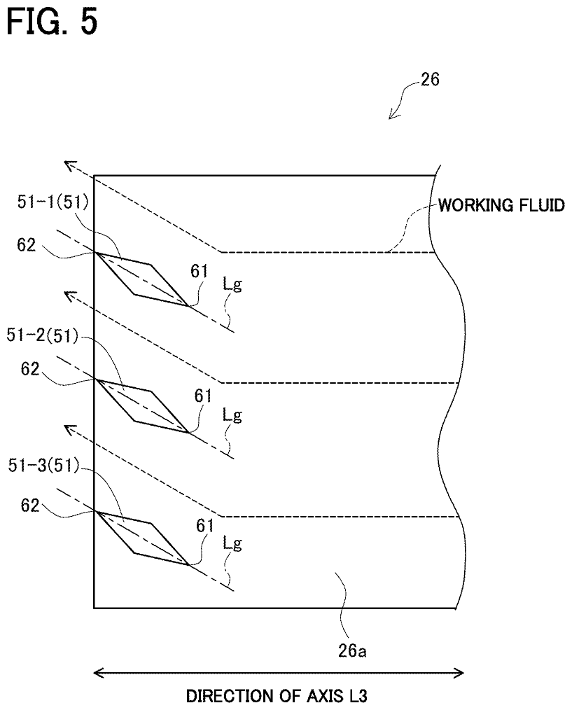

In this second example, as shown in FIG. 5, the nozzle guides 51 are arranged so that each axis Lg is slanted with respect to a flowing direction of the working fluid, that is, with respect to the axis L3 of the outer nozzle 26, or the horizontal direction in FIG. 5. Herein, the axis Lg is a line connecting the upstream-side end 61 and the downstream-side end 62 of each nozzle guide 51 as shown in FIG. 5.

In the present example, the axis Lg of each nozzle guide 51 is slanted with respect to the flowing direction of the working fluid as described above. Accordingly, these nozzle guides 51 enable the working fluid to swirl in a circumferential direction of the inner nozzle 25 and the outer nozzle 26, i.e., the vertical direction in FIG. 5, in flowing through the gap between the inner and outer nozzles 25 and 26, so that the swirling working fluid is injected from the outer injection port 32. This working fluid injected from the outer injection port 32 acts to easily flow the target fluid, so that the amount of the target fluid to be sucked to the diffuser 27 can be increased. Consequently, the ejector 1 can efficiently discharge a fluid mixture of the target fluid and the working fluid from the discharge port 28.

### Third Example

Next, a third example will be described below with a focus on differences from the first and second examples, and similar or identical parts to those in the first and second examples are not described.

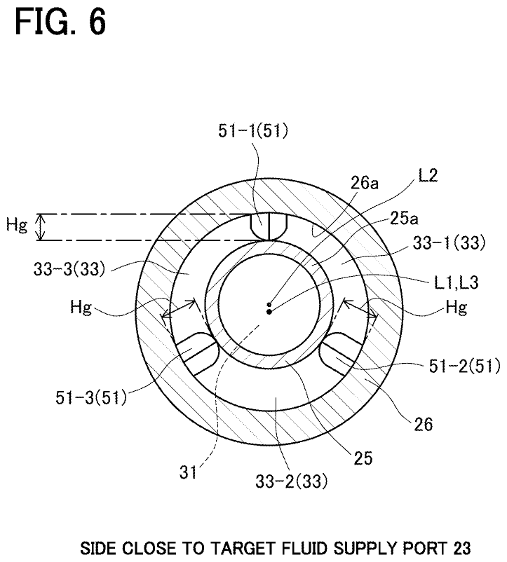

In this third example, as shown in FIG. 6, the nozzle guide(s) 51 located on the side closer to the target fluid supply port 23 (i.e., on the lower side in FIG. 6) has a higher height Hg as compared the remaining nozzle guide(s) 51. Herein, the height Hg represents the width of each nozzle guide 51 in the radial direction of the inner nozzle 25 and the outer nozzle 26.

In this manner, the height Hg of the nozzle guide(s) 51 located on the side closer to the target fluid supply port 23 is higher than that of the remaining nozzle guide(s) 51, so that the inner nozzle 25 is positioned eccentrically to the side opposite the target fluid supply port 23, i.e., to the upper side in FIG. 6, with respect to the outer nozzle 26, as shown in FIG. 6. Since the axis L2 of the inner nozzle 25 is located eccentrically above the axis L3 of the outer nozzle 26 as mentioned above, the annular cross-sectional area of the outer injection port 32 when seen in the direction of the axis L2 of the inner nozzle 25 or the axis L3 of the outer nozzle 26, that is, when cut perpendicular to the axis L2 or L3, is larger on the side closer to the target fluid supply port 23, i.e., on the lower side in FIG. 6.

In this example, specifically, three nozzle guides 51; a first nozzle guide 51-1, a second nozzle guide 51-2, and a third nozzle guide 51-3, are designed with different heights Hg such that the height Hg of the first nozzle guide 51-1 is smaller than each of the height Hg of the second nozzle guide 51-2 and the height Hg of the third nozzle guide 51-3. Thus, the flow channel 33 divided by the three nozzle guides 51 into three channels, a first flow channel 33-1, a second flow channel 33-2, and a third flow channel 33-3, has the cross-sectional areas such that the cross-sectional area of the second flow channel 33-2 located on the side closer to the target fluid supply port 23 is larger than the cross-sectional area of each of the first flow channel 33-1 and the third flow channel 33-3. This flow channel 33 is a flow passage defined between the outer periphery 25a of the inner nozzle 25 and the inner periphery 26a of the outer nozzle 26 and connected to the outer injection port 32.

As described above, the inner nozzle 25 is forced to be eccentric with respect to the outer nozzle 26 by shifting the axis L2 of the inner nozzle 25 to the side far from the target fluid supply port 23 (i.e., to the above side in FIG. 6) relative to the axis L3 of the outer nozzle 26. This arrangement can increase a flow rate of the working fluid injected from a part of the outer injection port 32 close to the target fluid supply port 23. It is thus possible to prevent a decrease in flow rate of the working fluid injected from the outer injection port 32 by the influence of inflow of the target fluid through the target fluid supply port 23. This ejector 1 can therefore maintain a flow rate of the target fluid caused to flow by the action of the working fluid.

### Fourth Example

Next, a fourth example will be described below with a focus on differences from the first to third examples, and similar or identical parts to those in the first to third examples are not described.

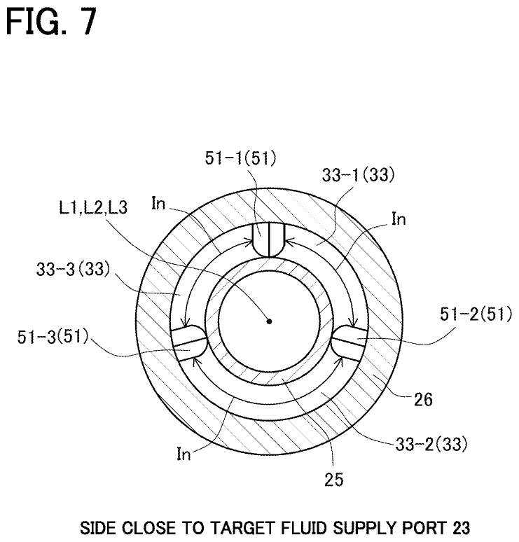

In this fourth example, as shown in FIG. 7, the nozzle guides 51 are arranged such that the intervals between the adjacent nozzle guides 51 in a circumferential direction of the inner nozzle 25 and the outer nozzle 26 (hereinafter, also referred to as the circumferential interval) are different to be larger on the side closer to the target fluid supply port 23. Accordingly, the annular cross-sectional area of the outer injection port 32 when seen in the direction of the axis L2 of the inner nozzle 25 or the axis L3 of the outer nozzle 26, that is, when cut perpendicular to the axis L2 or L3, is larger on the side closer to the target fluid supply port 23.

Specifically, three nozzle guides 51; a first nozzle guide 51-1, a second nozzle guide 51-2, and a third nozzle guide 51-3, are arranged so that the circumferential interval In between the second nozzle guide 51-2 and the third nozzle guide 51-3, located on the side closer to the target fluid supply port 23 relative to the first nozzle guide 51-1, is larger than the circumferential interval In between the first nozzle guide 51-1 and the second nozzle guide 51-2 and the circumferential interval In between the first nozzle guide 51-1 and the third nozzle guide 51-3. Thus, the flow channel 33 divided by the three nozzle guides 51 into three channels connected to the outer injection port 32; a first flow channel 33-1, a second flow channel 33-2, and a third flow channel 33-3, has the cross-sectional areas such that the cross-sectional area of the second flow channel 33-2 located on the side closer to the target fluid supply port 23 is larger than the cross-sectional area of each of the first flow channel 33-1 and the third flow channel 33-3.

Thus, as in the third example, it is possible to prevent a decrease in flow rate of the working fluid injected from the outer injection port 32 by the influence of inflow of the target fluid through the target fluid supply port 23. This ejector 1 can therefore maintain a flow rate of the target fluid caused to flow by the action of the working fluid.

### Modified Example

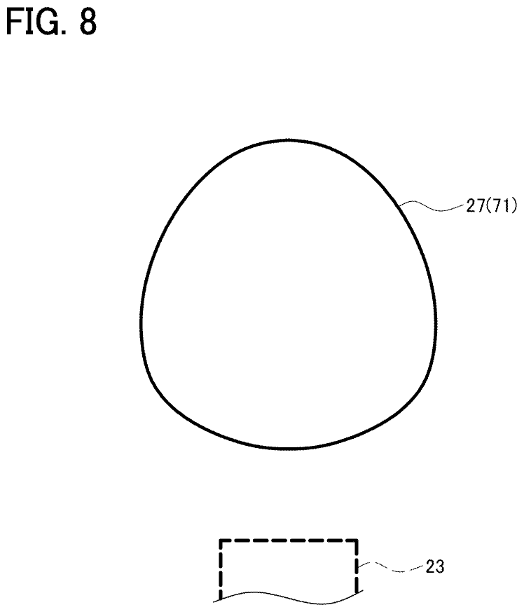

As a modified example, the suction port 71 of the diffuser 27 in the first to fourth examples may be designed with an oval shape having an opening area wider on the side closer to the target fluid supply port 23, i.e., on the lower side in FIG. 8, than on another side, i.e., on the upper side in FIG. 8.

This configuration can facilitate suction of the target fluid into the diffuser 27 through the wider portion of the suction port 71 on the side close to the target fluid supply port 23. It is therefore possible to increase the amount of target fluid to be sucked into the diffuser 27, resulting in an increase in a flow rate of the target fluid.

The foregoing embodiments are mere examples and give no limitation to the present disclosure. The present disclosure may be embodied in other specific forms without departing from the essential characteristics thereof.

For instance, the shape of each nozzle guide 51 may be of any other shapes, e.g., a rectangular prism having diamond-shaped top and bottom faces, a rectangular parallelepiped shape, a cubic shape, a circular cylinder shape, or other prism shapes.

In the above examples, the inner nozzle 25 and the outer nozzle 26 are constituted as a double-tube nozzle. As an alternative, a triple- or more tube nozzle may be adopted.

In the above description, the outer nozzle may include the distal end portion internally provided with the outer injection port, and the interval restricting part may be placed at the upstream position from the outer injection port in the flowing direction of the working fluid.

According to the above configuration, the inner nozzle and the outer nozzle can be maintained in a desired positional relationship without decreasing a flow rate of the working fluid injected from the outer injection port.

In the above description, the interval restricting part may include the upstream-side end that is located on the upstream side in the flowing direction of the working fluid and has a shape converging toward the upstream side.

The above configuration can prevent the interval restricting part from acting as a resistance to the working fluid, thus preventing the flow rate of the working fluid to be injected from the gap defined between the inner nozzle and the outer nozzle from decreasing due to the interval restricting part.

In the above description, the interval restricting part may include the downstream-side end that is located on the downstream side in the flowing direction of the working fluid and has a shape converging toward the downstream side.

According to the above configuration, the interval restricting part can rectify a flow of the working fluid. Such a rectified flow of the working fluid allows the target fluid to flow more stably, so that a flow rate of the target fluid is stabilized.

In the above description, the ejector may include the target fluid supply port through which the target fluid is supplied to the ejector, and the gap may have a cross-sectional area that is larger as it is closer to the target fluid supply port when the gap is seen in the direction of the axis of the inner nozzle.

This configuration can increase a flow rate of the working fluid injected from a part of the gap between the inner nozzle and the outer nozzle, close to the target fluid supply port, as compared with a remaining part(s) of the gap. Thus, it is possible to prevent a decrease in flow rate of the working fluid injected from the gap between the inner nozzle and the outer nozzle by the influence of inflow of the target fluid through the target fluid supply port. This ejector can therefore maintain a flow rate of the target fluid caused to flow by the action of the working fluid.

In the above description, the interval restricting part may be placed so that the axis connecting the upstream-side end and the downstream-side end of the interval restricting part in the flowing direction of the working fluid is slanted with respect to the flowing direction of the working fluid.

According to the above configuration, the axis of the interval restricting part is slanted with respect to the flowing direction of the working fluid, so that the interval restricting part enables the working fluid to swirl in a circumferential direction of the inner nozzle and the outer nozzle in flowing through the gap between the inner nozzle and the outer nozzle, so that the swirling working fluid is injected from the gap. This working fluid injected from the gap between the inner nozzle and the outer nozzle acts to easily flow the target fluid, resulting in an increase in the amount of the target fluid to be sucked.

In the above description, the ejector may further include the target fluid supply port through which the target fluid is supplied to the ejector, and the diffuser configured to suck the target fluid by negative pressure that is generated by the working fluid and deliver the target fluid merged with the working fluid to the discharge port. The diffuser may include an oval-shaped suction port with the opening area wider on one side closer to the target fluid supply port than on another side.

This configuration can facilitate suction of the target fluid into the diffuser through the portion of the suction port on the side close to the target fluid supply port. It is therefore possible to increase the amount of target fluid to be sucked into the diffuser, resulting in an increase in a flow rate of the target fluid.

### REFERENCE SIGNS LIST

1 Ejector
11 Body casing
25 Inner nozzle
26 Outer nozzle
27 Diffuser
28 Discharge port
31 Inner injection port
32 Outer injection port
33 Flow channel
41 Distal end portion (of inner nozzle)
42 Distal end portion (of outer nozzle)
51 Nozzle guide
61 Upstream-side end
62 Downstream-side end
71 Suction port
Lg Axis (of nozzle guide)

What is claimed is:

1. An ejector comprising:
an inner nozzle; and
an outer nozzle internally provided with the inner nozzle,
wherein the inner nozzle and the outer nozzle are spaced with a gap,
the ejector is configured to suck a target fluid by negative pressure that is generated by a working fluid injected from at least one of an inside of the inner nozzle and the gap and discharge the target fluid merged with the working fluid, and
the ejector includes an interval restricting part placed in the gap and configured to restrict an interval of the gap.

2. The ejector according to claim 1, wherein
the outer nozzle includes a distal end portion internally provided with an outer injection port, and
the interval restricting part is placed at an upstream position from the outer injection port in a flowing direction of the working fluid.

3. The ejector according to claim 1, wherein the interval restricting part includes an upstream end located on an upstream side in a flowing direction of the working fluid, the upstream end having a shape that converges toward the upstream side.

4. The ejector according to claim 2, wherein the interval restricting part includes an upstream end located on an upstream side in the flowing direction of the working fluid, the upstream end having a shape that converges toward the upstream side.

5. The ejector according to claim 1, wherein the interval restricting part includes a downstream end located on a downstream side in a flowing direction of the working fluid, the downstream end having a shape that converges toward the downstream side.

6. The ejector according to claim 2, wherein the interval restricting part includes a downstream end located on a downstream side in the flowing direction of the working fluid, the downstream end having a shape that converges toward the downstream side.

7. The ejector according to claim 1, further comprising a target fluid supply port through which the target fluid is supplied to the ejector, and
wherein the gap has a cross-sectional area that is larger as it is closer to the target fluid supply port when the gap is seen in an axis direction of the inner nozzle.

8. The ejector according to claim 2, further comprising a target fluid supply port through which the target fluid is supplied to the ejector, and
wherein the gap has a cross-sectional area that is larger as it is closer to the target fluid supply port when the gap is seen in an axis direction of the inner nozzle.

9. The ejector according to claim 1, wherein the interval restricting part is placed so that an axis connecting an upstream end and a downstream end of the interval restricting part in a flowing direction of the working fluid is slanted with respect to the flowing direction of the working fluid.

10. The ejector according to claim 2, wherein the interval restricting part is placed so that an axis connecting an upstream end and a downstream end of the interval restricting part in the flowing direction of the working fluid is slanted with respect to the flowing direction of the working fluid.

11. The ejector according to claim 1, further comprising:
a target fluid supply port through which the target fluid is supplied to the ejector; and
a diffuser configured to suck the target fluid by negative pressure that is generated by the working fluid and deliver the target fluid merged with the working fluid to a discharge port, and
wherein the diffuser includes an oval-shaped suction port with a wider opening area on one side closer to the target fluid supply port than on another side.

12. The ejector according to claim 2, further comprising:
a target fluid supply port through which the target fluid is supplied to the ejector; and
a diffuser configured to suck the target fluid by negative pressure that is generated by the working fluid and deliver the target fluid merged with the working fluid to a discharge port, and
wherein the diffuser includes an oval-shaped suction port with a wider opening area on one side closer to the target fluid supply port than on another side.
